(19) United States
(12) Patent Application Publication
(10) Pub. No.: US 2024/0384557 A1
(43) Pub. Date: Nov. 21, 2024

(54) Flag Display Device

(71) Applicant: Fast-Flag LLC, Naples, FL (US)

(72) Inventor: Tunc Hamami, Naples, FL (US)

(21) Appl. No.: 18/712,895

(22) PCT Filed: Aug. 16, 2021
(86) PCT No.: PCT/US2021/046071

§ 371 Date: May 23, 2024

(51) Int. Cl. E04H 12/32; E04H 12/22; G09F 13/02; G09F 17/00

(52) U.S. Cl. CPC E04H 12/32; E04H 12/2261; G09F 13/02; G09F 2017/0066; G09F 2017/0075

(57) ABSTRACT

A flag display device (1) used for fully displaying a flag regardless of the presence of wind and/or in the dark. The flag display device supports a preferably interchangeable display panel (3) extending between a top horizontal support arm (7) and a bottom horizontal support arm (8) that each extend perpendicularly from a vertical mast (4). At least one display light source (22) illuminates the display panel at night.

### FIELD OF THE INVENTION

This invention relates generally to flags and devices for displaying flags and more particularly to a flag display device that fully displays a flag regardless of the presence of wind and/or sunlight.

### BACKGROUND OF THE INVENTION

Conventional cloth and nylon flags are flown or displayed by attaching grommets located on an edge of a flag to hooks and rope supported by a vertical mast or flagpole. Flags, particularly the American flag, convey powerful messages and provide an aesthetic beauty when wind is blowing on the flag and the flag is flying fully extended in all its glory.

Unfortunately, when wind is not present, conventional flags simply droop and fail to provide all their intended benefits. An additional problem occurs at night when conventional flags are not visible due to darkness. Both wind and light are the two main requirements for properly displaying a conventional cloth flag.

Therefore, a need exists for a flag display device that fully displays a flag regardless of the presence of wind and/or in the dark.

### SUMMARY OF THE INVENTION

The primary object of the present invention is to provide a flag display device that fully displays a flag regardless of the presence of wind and/or in the dark.

The present invention fulfills the above and other objects by providing a flag display device having a preferably oval vertical mast that is mountable to a surface, such as a surface of a boat, from where the vertical mast extends upward and terminates at a top end. A preferably oval-shaped top horizontal support arm extends perpendicularly from the vertical mast below the top end of said vertical mast. Likewise, a preferably oval-shaped bottom horizontal support arm extends perpendicularly from the vertical mast below the top horizontal support arm.

The top horizontal support arm and the bottom horizontal support arm are parallel to each other and are spaced apart to support at least one rigid or non-rigid display panel having a design located thereon wherein the design may be printed and/or at least one cutout forming said design. For example, the display panel may have an American flag printed on one or more surfaces. Likewise, the display panel may have an American flag design cutout so that negative spaces or cutout portions form the stars and stripes of the American flag.

The flag display device preferably has at least one display light source, such as an LED, located on a bottom surface of the top horizontal support and/or at least one display light source located on a top surface of the bottom horizontal support arm. The at least one display light source may be powered by a hardwired energy source and/or at least one rechargeable battery powered by at least one solar or photovoltaic panel. The at least one display light source may shine light onto an exterior surface of a display panel or shine light through the display panel from an interior space created when there are two display panels as described below.

The top horizontal support arm and bottom horizontal support arm may support two display panels that are spaced apart to provide space for at least one display light source to be positioned between the two display panels. The two display panels may be supported in positions that form a corresponding tear-drop shape with the top horizontal support arm and the bottom horizontal support arm. Said display panels may be translucent and/or have one or more cutouts to allow light pass through to illuminate the display panels at night.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a side view of a flag display device of the present invention in use on a stationary boat with no wind present;

FIG. 2 is a front perspective view of the flag display device;

FIG. 3 is a rear perspective view of the flag display device thereof;

FIG. 4 is a right side view of the flag display device thereof;

FIG. 5 is a left side view of the flag display device thereof;

FIG. 6 is a front view of the flag display device thereof;

FIG. 7 is a rear view of the flag display device thereof;

FIG. 8 is a top plan view of the flag display device thereof;

FIG. 9 is rear perspective view of the flag display device further illustrating a display light source and engagement of at least one rigid panel thereto;

FIG. 10 is a sectional view along lines A-A of FIG. 9;

FIG. 11 is an exploded rear perspective view of the flag display device further illustrating a display light source and engagement of at least one rigid panel thereto;

FIG. 12 is a right side plan view of the flag display device thereof;

FIG. 13 is a side view of the flag display device of the present invention having an interchangeable panel that is inserted through the top horizontal support arm;

FIG. 14 is a top view of a top horizontal support arm of the flag display device of the present invention;

FIG. 15 is a top view of a bottom horizontal support arm of the flag display device of the present invention;

FIG. 16 is a sectional view along lines A-A of FIG. 15;

FIG. 17 is a sectional view along lines B-B of FIG. 15;

FIG. 18 is a side view of a flag display device of the present invention supported by an L-shaped mounting bracket;

FIG. 19 is a rear view of an L-shaped mounting bracket; and

FIG. 20 is a side view of a flag display device of the present invention supported by a trailer hitch bracket.

FIG. 21 is a right side view of a flag display device of the present invention having a hinged base and an angled vertical mast;

FIG. 22 is a left side view of the flag display device of the present invention having a hinged base and an angled vertical mast;

FIG. 23 is a front view of the flag display device of the present invention having a hinged base and an angled vertical mast;

FIG. 24 is a rear view of flag display device of the present invention having a hinged base and an angled vertical mast;

FIG. 25 is a top view of flag display device of the present invention having a hinged base and an angled vertical mast;

FIG. 26 is a bottom view of the flag display device of the present invention having a hinged base and an angled vertical mast;

FIG. 27 is a cross sectional view along line C-C of FIG. 20 of the flag display device of the present invention having a hinged base and an angled vertical mast;

FIG. 28 is a rear view of a flag display device being folded over, using the hinged base; and

FIG. 29 is a side view of a flag display device of the present invention having an angled design.

### DESCRIPTION OF THE PREFERRED EMBODIMENTS

For purposes of describing the preferred embodiment, the terminology used in reference to the numbered accessories in the drawings is as follows:
1. flag display device, generally
2. boat
3. display panel
4. vertical mast
5. bottom end of vertical mast
6. top end of vertical mast
7. top horizontal support arm
8. bottom horizontal support arm
9. top edge of display panel
10. bottom edge of display panel
11. design
12. bottom mounting plate
13. top mounting plate
14. top surface of top horizontal support arm
15. bottom surface of top horizontal support arm
16. distal end of top horizontal support arm
17. top surface of bottom horizontal support arm
18. bottom surface of bottom horizontal support arm
19. distal end of bottom horizontal support arm
20. attachment means
21. channel
22. display light source
23. solar panel
24. retaining means
25. navigation light
26. slot
27. battery
28. L-shaped bracket
29. tool box
30. horizontal plate
31. vertical plate
32. support arm
33. trailer hitch bracket
34. hitch shank
35. top leaf
36. bottom leaf
37. knuckle
38. pin
39. rear edge of base
40. front edge of display panel
41. rear edge of display panel
42. third support arm

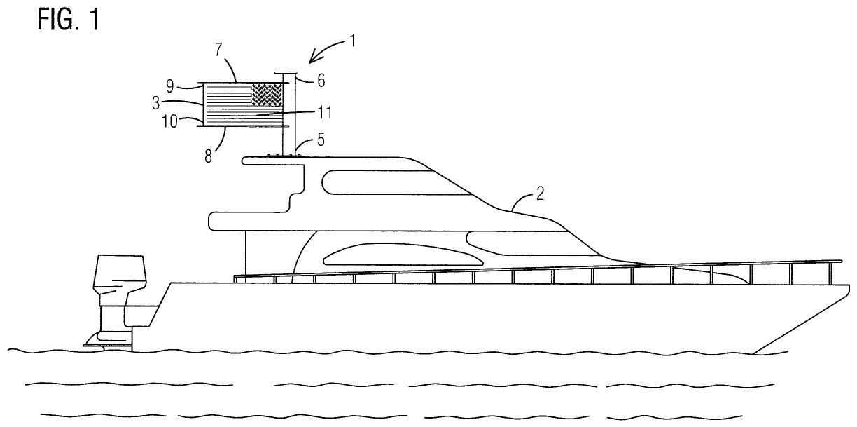

With reference to FIG. 1, a side view of a flag display device 1 of the present invention in use on a stationary boat 2 with no wind present is illustrated. The flag display device 1 supports a preferably rigid rectangular-shaped display panel 3, having a flag or other design thereon, regardless of the presence of wind and/or in the dark. A bottom end 5 of a vertical mast 4 is mounted to a surface of the boat 2 and extends upward prior to terminating at a top end 6 thereof. At least one display panel 3 is supported between a top horizontal support arm 7 and a bottom horizontal support arm 8 that engage a top edge 9 of the at least one display panel 3 and a bottom edge 10 of the display panel 3, respectively. The at least one display panel 3 is preferably interchangeable to allow a user to select between multiple display panels 3 each having a unique flag, indicia or other design 11 being displayed thereon that is integrated into the display panel 3 and/or attachable to the display panel 3 via magnets or adhesive. As illustrated herein, the at least one display panel 3 comprises an American flag as the design 11 being presented. The design 11 on each display panel 3 may be magnetic overlays

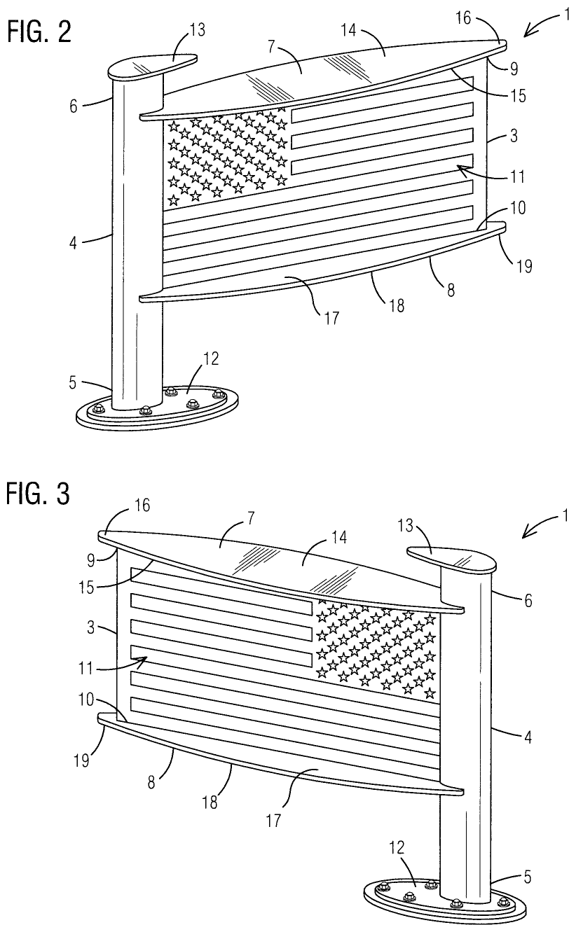

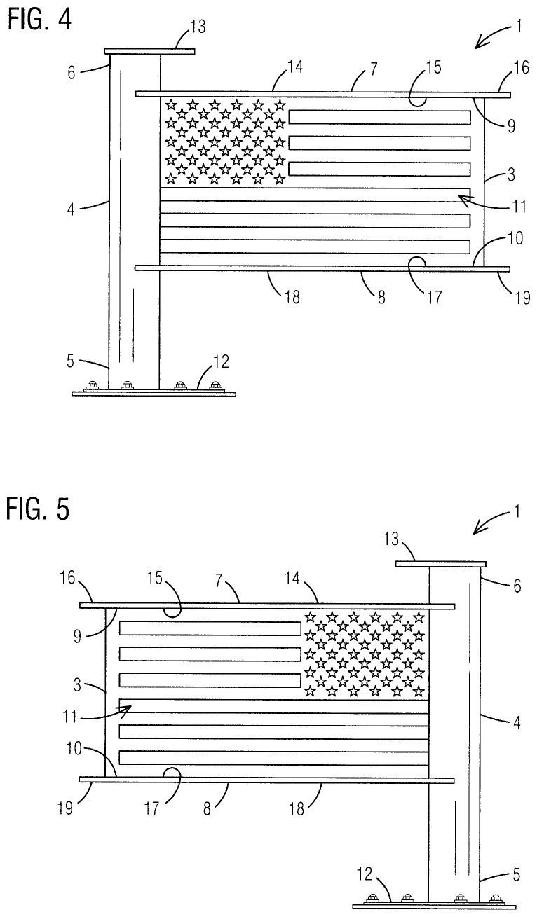

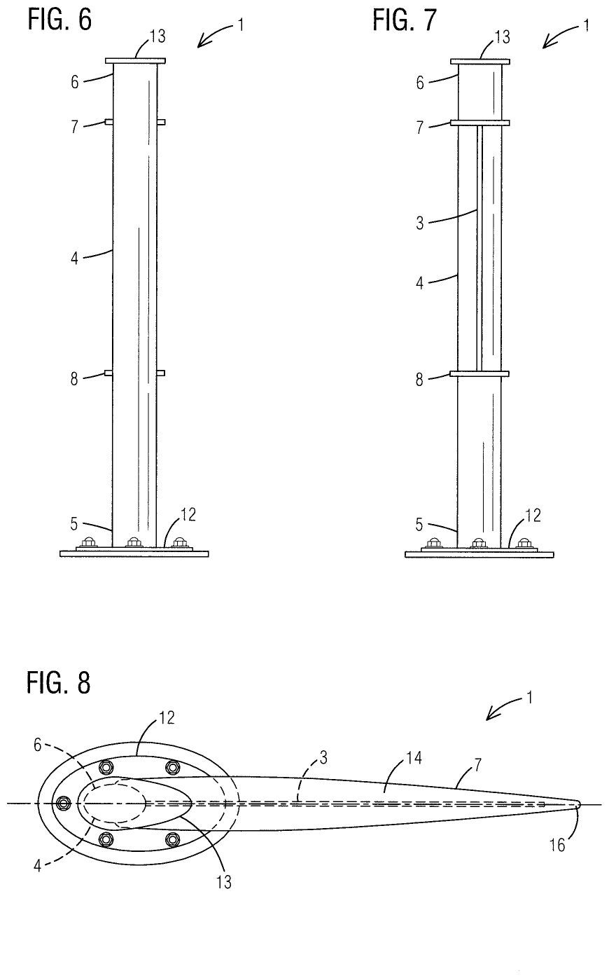

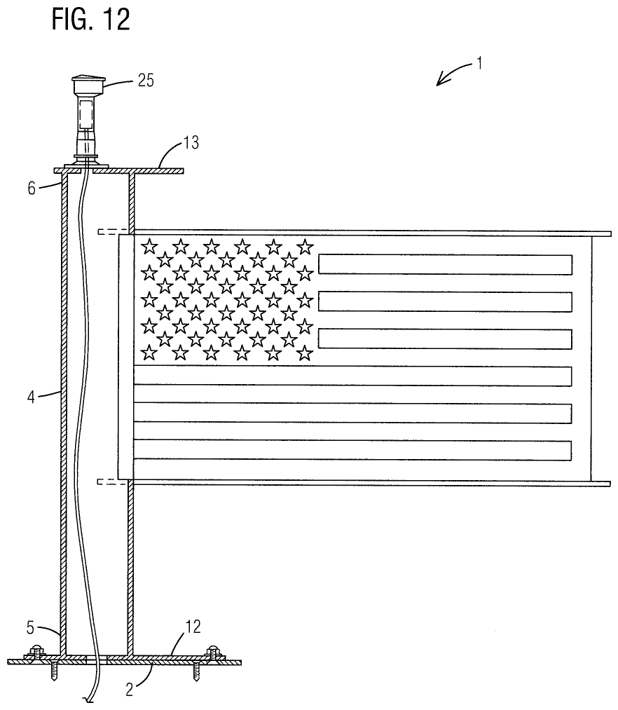

With reference to FIGS. 2-7, multiple views of a flag display device 1 of the present invention are illustrated. The flag display device 1 comprises a preferably oval-shaped vertical mast 4 having a bottom end 5 and a top end 6. A bottom mounting plate 12 is preferably located on the bottom end 5 of the vertical mast 4 to provide a means for mounting said vertical mast 4 to a mounting surface, such as a boat 2. A top mounting plate 13, such as a cap, is preferably located on the top end 6 of the vertical mast 4 to provide a means for mounting one or more accessories, to the top end 6 of the vertical mast 3, as further illustrated in FIG. 12.

A preferably oval-shaped top horizontal support arm 7 having a top surface 14 and a bottom surface 15 extends perpendicularly from the vertical mast 4 below the top end 6 of said vertical mast 4 and terminates at a distal end 16 thereof. Likewise, a preferably oval-shaped bottom horizontal support arm 8 having a top surface 17 and a bottom surface 18 extends perpendicularly from the vertical mast 4 below the top horizontal support arm 7 and terminates at a distal end 19 thereof.

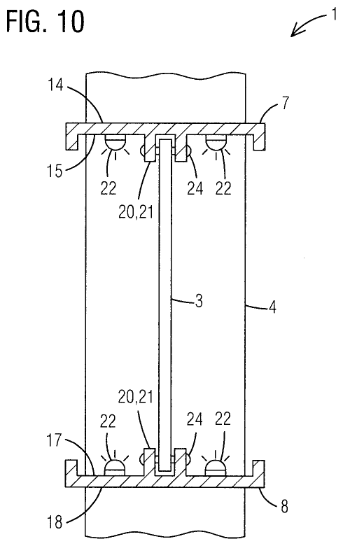

The top horizontal support arm 7 and bottom horizontal support arm 8 are parallel to each other and are spaced apart to support at least one display panel 3 having a design 10 thereon wherein said design may be printed and/or the design may be formed from at least one cutout. Said at least one display panel 3 is preferably interchangeable and secured to the top horizontal support arm 7 and bottom horizontal support arm 8 via at least one attachment means 20, such as a channel 21 that engage the top edge 9 of the at least one display panel 3 and a bottom edge 10 of the display panel 3, respectively, as illustrated in FIG. 10.

With reference to FIG. 8, a top plan view of a flag display device 1 of the present invention is illustrated. The vertical mast 4, top horizontal support arm 7 and bottom horizontal support arm 8 are each preferably substantially oval-shaped when looking a top profile or bottom profile. The oval-shape provides decreased wind resistance when the flag display device 1 is in motion on a boat 2 or other moving object.

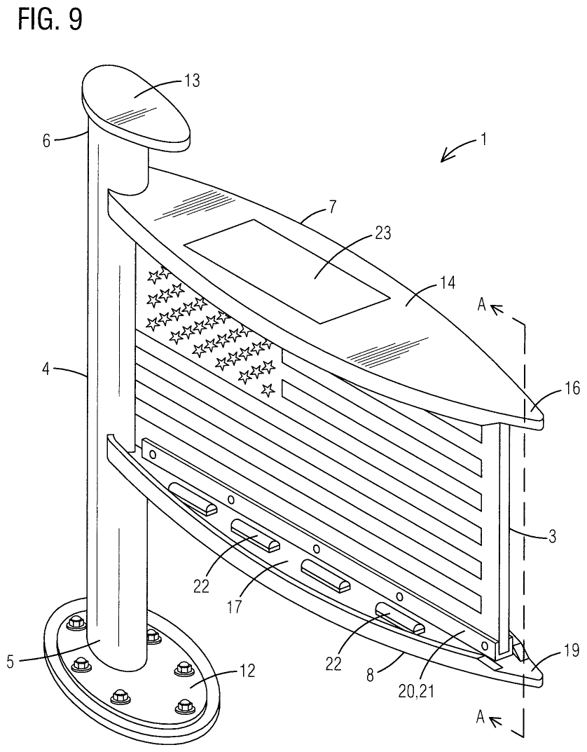

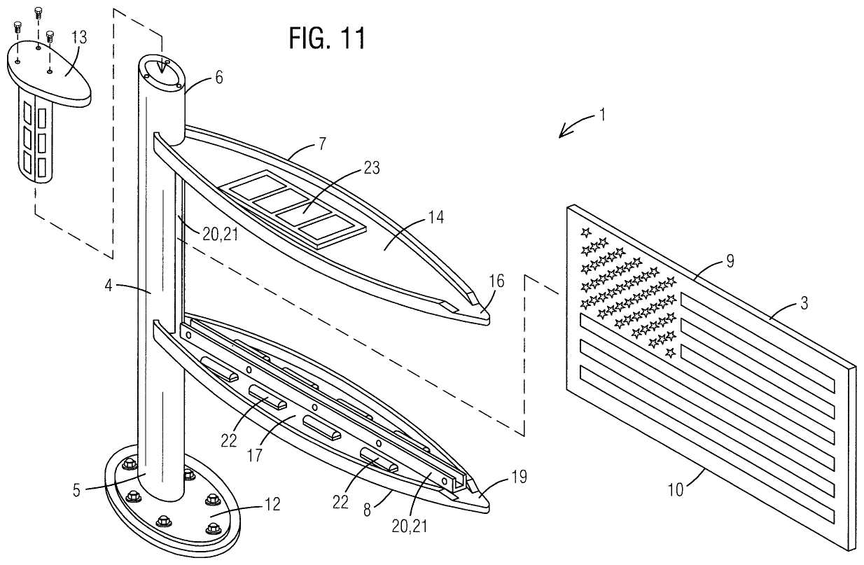

With reference to FIGS. 9-11, a perspective rear view and a sectional view of an illuminated flag display device 1 of the present invention are illustrated. The flag display device 1 comprises a vertical mast 4 having a bottom end 5 and a top end 6. A bottom mounting plate 12 is preferably located on the bottom end 5 of the vertical mast 4 to provide a means for mounting said vertical mast 4 to a mounting surface, such as a boat 2. A top mounting plate 13, such as a cap, is preferably located on the top end 6 of the vertical mast 4 to provide a means for mounting one or more accessories, to the top end 6 of the vertical mast 4, as illustrated in FIG. 12.

A preferably oval-shaped top horizontal support arm 7 having a top surface 14 and a bottom surface 15 extends perpendicularly from the vertical mast 4 below the top end 6 of said vertical mast 4 and terminates at a distal end 16 thereof. Likewise, a preferably oval-shaped bottom horizontal support arm 8 having a top surface 17 and a bottom surface 18 extends perpendicularly from the vertical mast 4 below the top horizontal support arm 7 and terminates at a distal end 19 thereof.

At least one display light source 22, such as an LED, may be located on the top horizontal support arm 7 and/or on the bottom horizontal support arm 8. The at least one display light source 22 is preferably located on the bottom surface 15 of the top horizontal support arm 7 and/or the top surface 17 of the bottom horizontal support arm 8. The at least one display light source 22 may be powered by a hardwired energy source and/or a rechargeable battery powered by at least one photovoltaic solar panel 23.

Said at least one display panel 3 is preferably interchangeable and secured to the top horizontal support arm 7, bottom horizontal support arm 8 and/or vertical mast 4 via at least one attachment means 20, such as a u-shaped channel 21 that engages the top edge 9 of the at least one display panel 3 and the bottom edge 10 of the display panel 3, respectively. A retaining means 24, such as a pin, bolt, screw, and do forth may be used to lock the at least one display panel 3 within the channels 21.

With reference to FIG. 12, a right side plan view of the flag display device 1 of the present invention is illustrated. The flag display device 1 comprises a preferably oval-shaped vertical mast 4 having a bottom end 5 and a top end 6. A bottom mounting plate 12 is preferably located on the bottom end 5 of the vertical mast 4 to provide a means for mounting said vertical mast 4 to a mounting surface, such as a boat 2. A top mounting plate 13, such as a cap, is preferably located on the top end 6 of the vertical mast 4 to provide a means for mounting one a navigation light 25 or other accessories, such as an antenna and so forth, to the top end 6 of the vertical mast 3. The mast 4 is preferably hollow to allow wiring to be run to the navigation light 25 and/or to the at least one display light source 22.

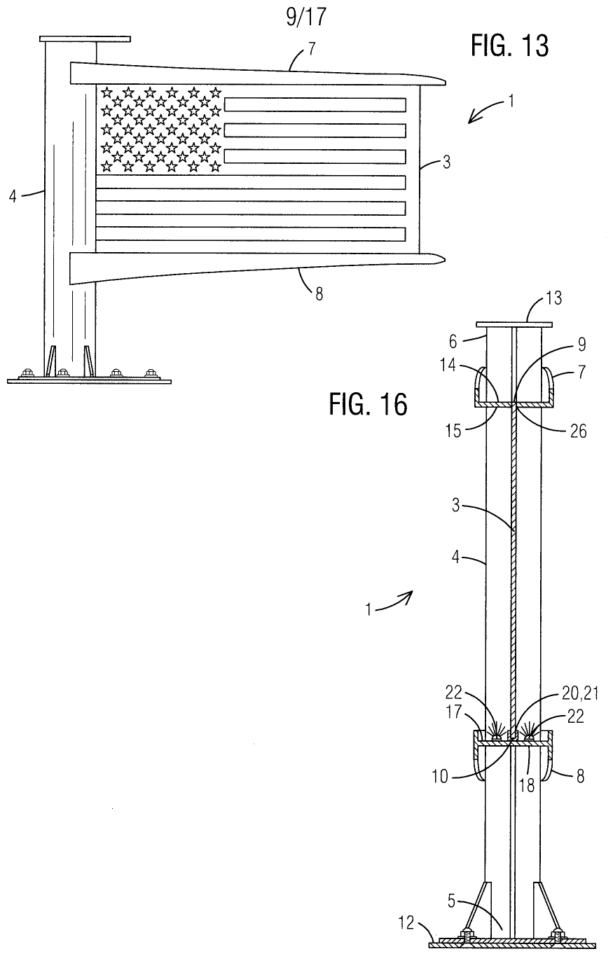

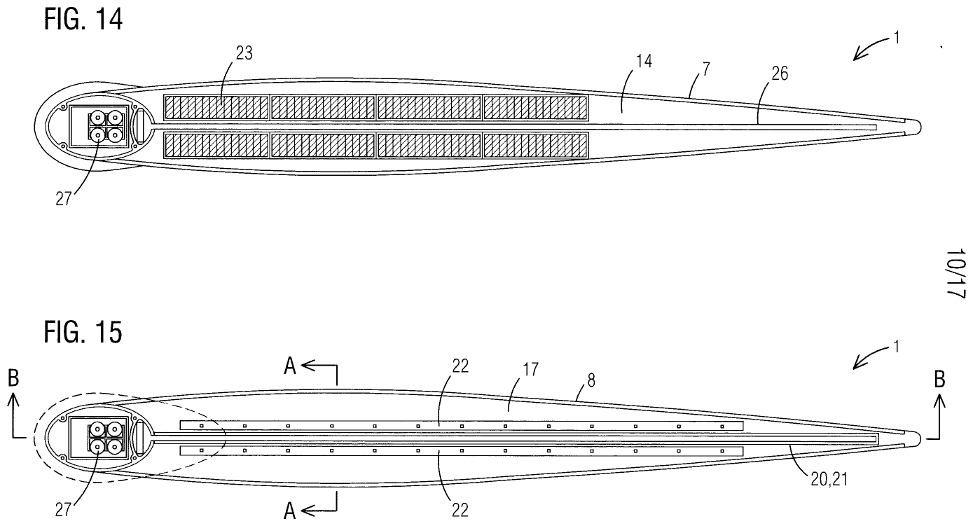

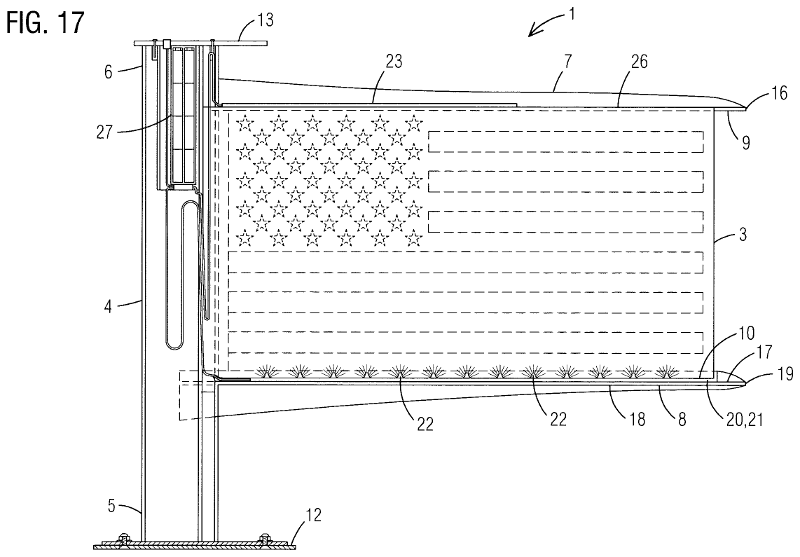

With reference to FIGS. 13-17, a flag display device 1 of the present invention having an interchangeable display panel 3 that is inserted through the top horizontal support arm 7 is illustrated. The flag display device 1 comprises a vertical mast 4 having a bottom end 5 and a top end 6. A bottom mounting plate 12 is preferably located on the bottom end 5 of the vertical mast 4 to provide a means for mounting said vertical mast 4 to a mounting surface, such as a boat 2. A top mounting plate 13, such as a cap, is preferably located on the top end 6 of the vertical mast 4.

A preferably oval-shaped top horizontal support arm 7 having a top surface 14 and a bottom surface 15 extends perpendicularly from the vertical mast 4 below the top end 6 of said vertical mast 4 and terminates at a distal end 16 thereof. Likewise, a preferably oval-shaped bottom horizontal support arm 8 having a top surface 17 and a bottom surface 18 extends perpendicularly from the vertical mast 4 below the top horizontal support arm 7 and terminates at a distal end 19 thereof.

At least one display light source 22, such as an LED, may be located on the top horizontal support arm 7 and/or on the bottom horizontal support arm 8. The at least one display light source 22 is preferably located on the bottom surface 15 of the top horizontal support arm 7 and/or the top surface 17 of the bottom horizontal support arm 8. The at least one display light source 22 may be powered by a hardwired energy source and/or at least one rechargeable battery 27 and/or battery pack powered by said at least one photovoltaic solar panel 23.

Said at least one display panel 3 is preferably interchangeable by placing a display panel 3 through a slot 26 located on the top horizontal support arm 7. A top edge 9 of the panel 3 is held in place by the slot 26 while a bottom edge 10 of the panel 3 is held in place by at least one attachment means 20, such as a u-shaped channel 21.

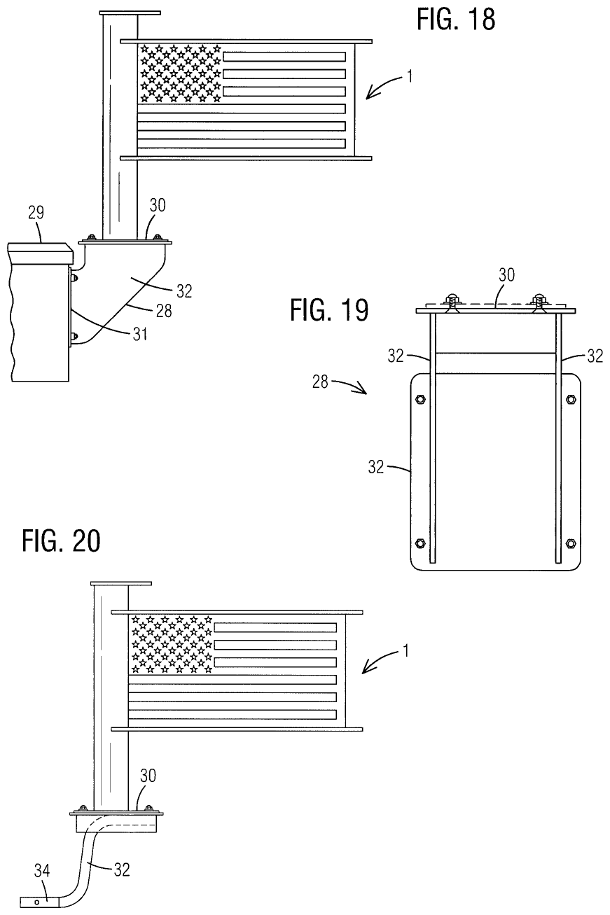

With reference to FIGS. 18 and 19, a side view of a flag display device 1 of the present invention supported by an L-shaped mounting bracket 28 and a rear view of the L-shaped mounting bracket 28, respectively, are illustrated. The flag display device 1 may be mounted to a vertical surface of an object, such as a toolbox 29, using the L-shaped bracket 28. Said L-shaped bracket comprises a horizontal plate 30 connected to a vertical plate 31 by at least one support arm 32.

With reference to FIG. 20, a side view of a flag display device 1 of the present invention supported by a trailer hitch bracket 33 is illustrated. The flag display device 1 may be supported by a hitch receiver using the trailer hitch bracket 33, which comprises a horizontal plate 30 connected to a hitch shank 34 by at least one support arm 32. Said hitch shank 34 engages a hitch receiver and is held in place by a hitch pin.

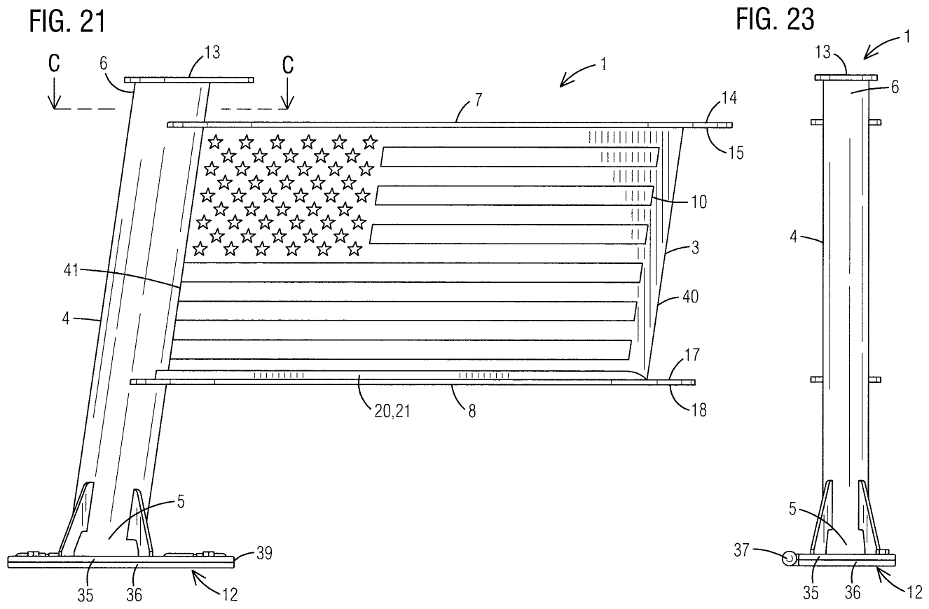

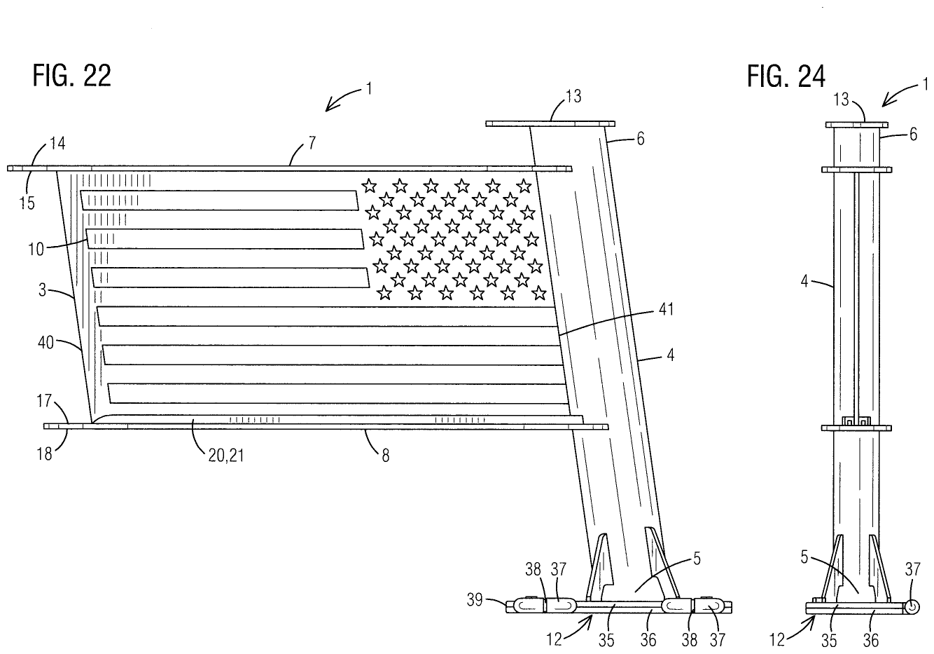

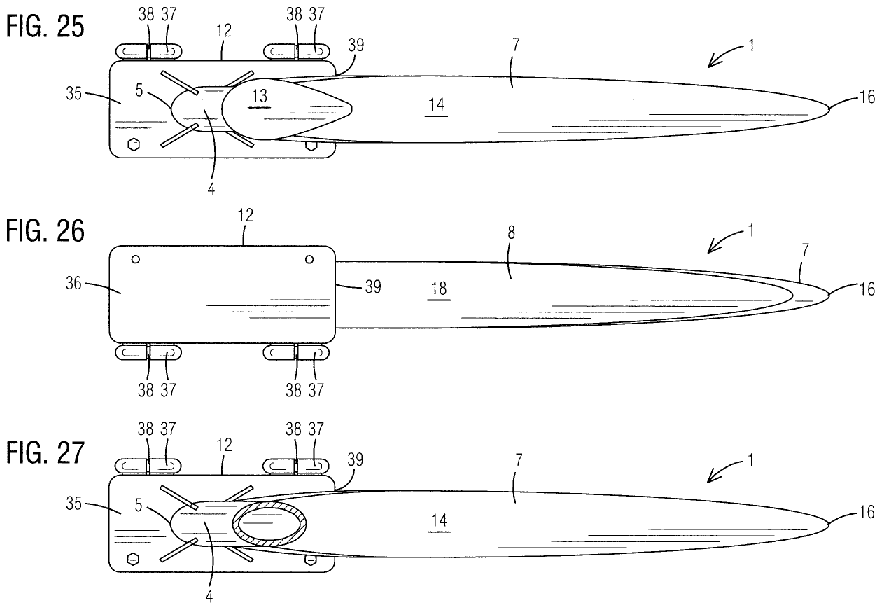

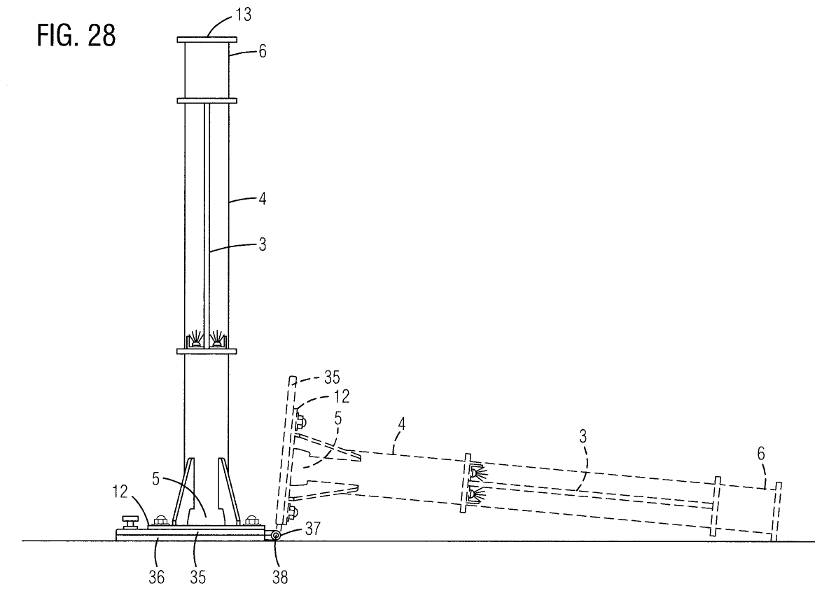

With reference to FIG. 20-28, various views of a flag display device 1 of the present invention having a hinged bottom mounting plate 12 and an angled vertical mast 4 are illustrated. The flag display device 1 comprises a preferably teardrop-shaped or oval-shaped vertical mast 4 having a bottom end 5 and a top end 6.

A hinged bottom mounting plate 12 is preferably located on the bottom end 5 of the angled vertical mast 4 to provide a means for mounting said angled vertical mast 4 to a mounting surface, such as a boat 2. The mounting plate 12 may be attached to a top leaf 35 or act as the top leaf 35 wherein a bottom leaf 36 is pivotally attached to the top leaf 35 on adjacent edges by at least one knuckle 37 and pin 38.

A top mounting plate 13, such as a cap, is preferably located on the top end 6 of the angled vertical mast 4 to provide a means for mounting one or more accessories, to the top end 6 of the angled vertical mast 4.

A preferably oval-shaped top horizontal support arm 7 having a top surface 14 and a bottom surface 15 extends perpendicularly from the vertical mast 4 below the top end 6 of said vertical mast 4 and terminates at a distal end 16 thereof. Likewise, a preferably oval-shaped bottom horizontal support arm 8 having a top surface 17 and a bottom surface 18 extends perpendicularly from the vertical mast 4 below the top horizontal support arm 7 and terminates at a distal end 19 thereof. One or more cameras may be mounted on the top horizontal support arm 7 and/or the bottom horizontal support arm 8.

The top horizontal support arm 7 and bottom horizontal support arm 8 are parallel to each other and are spaced apart to support at least one display panel 3 having a design 10 thereon wherein said design may be printed and/or the design may be formed from at least one cutout. Said at least one display panel 3 is preferably interchangeable and secured to the top horizontal support arm 7 and bottom horizontal support arm 8 via at least one attachment means 20, such as a channel 21 that engage the top edge 9 of the at least one display panel 3 and a bottom edge 10 of the display panel 3, respectively, as illustrated in FIG. 10.

The angled vertical mast 4 extends upward toward a rear edge 39 of the mounting plate 12. In addition, the display panel 3 is rhomboid-shaped wherein an angled front edge 40 and angled rear edge 41 of the display panel 3 are both parallel to the angled vertical mast 4, thereby providing additional aerodynamics and providing an appearance of movement while flag display device 1 is in a stationary position.

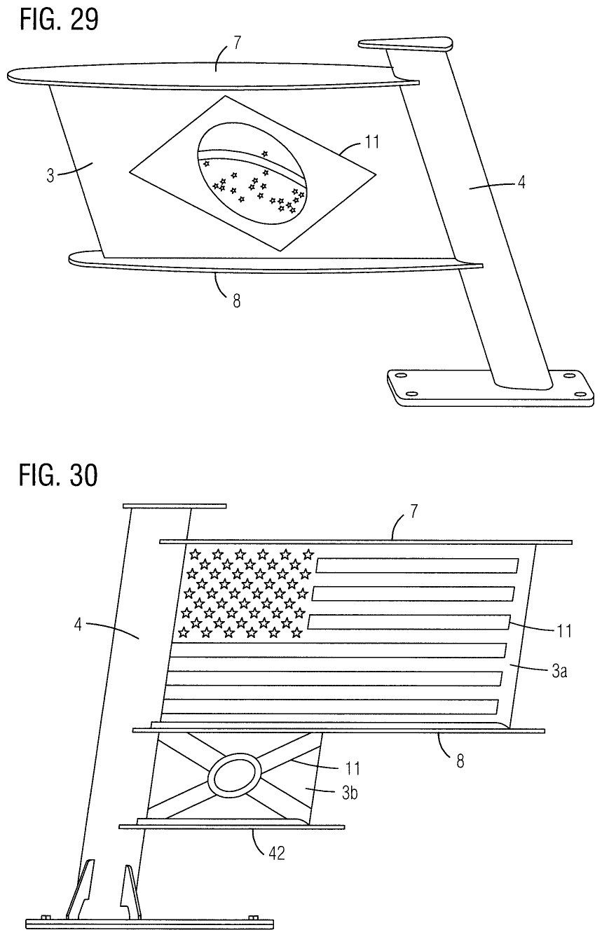

With reference to FIG. 29, a side view of a flag display device 1 of the present invention having an angled design is illustrated. The flag display device 1 comprises an angled vertical mast 4. A top horizontal support arm 7 and bottom horizontal support arm 8 are parallel to each other and are spaced apart to support at least one display panel 3 having a design 11 thereon wherein said design may be printed and/or the design may be formed from at least one cutout. As illustrated here, the design 11 is printed on a rhombus-shaped applique that is adhered to the panel 3. The design 11 is printed at an angle so that any vertical lines in the design are parallel to the angled vertical mast 4. The angled design 11 provides an appearance that flag display device 1 is in motion even when stationary.

With reference to FIG. 30, a side view of a flag display device 1 of the present invention having a third support arm 42 for supporting a second display panel 3b is illustrated. The flag display device 1 comprises an angled vertical mast 4. A top horizontal support arm 7 and bottom horizontal support arm 8 are parallel to each other and are spaced apart to support a main display panel 3a having a design 11 thereon wherein said design may be printed and/or the design may be formed from at least one cutout. A third support arm 42 is located below the bottom horizontal support arm 8 and is parallel to the bottom horizontal support arm 8 to support a second display panel 3b. As illustrated herein, the main display panel is the U.S. flag and the second display panel 3b is the state flag of Florida.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

1.-7. (canceled)

8. A flag assembly comprising:
a mast having a proximal end and a distal end with a length extending between the proximal end and the distal end;
a first support, the first support projecting away from the mast in a first support location;
a second support, the second support projecting away from the mast in a second support location, the second support location being intermediate of the distal end and the proximal end of the mast, the second support location being closer to the proximal end of the mast than the first support location, the first support location being closer to the distal end of the mast than the second support location; and
a flag element disposed between the first and second supports;
wherein the first support projects away from the mast in a first support projection direction, the second support projects away from the mast in a second support projection direction, the first support projection direction and the second support projection direction are parallel to each other;
wherein the mast is adapted and configured to be mounted to an object at or adjacent to the proximal end of the mast in a manner such that the mast projects away from the object in a direction extending from the proximal end of the mast to the distal end of the mast at an angle toward the first support projection direction and the second support projection direction; and
wherein the proximal end of the mast comprises a hinge assembly, the hinge assembly includes a first portion that is adapted and configured for connection with the object, and a second portion that is hingedly connected to the first portion with the mast projecting from the second portion, the hinge assembly define a pivot axis parallel to the first support projection direction and the second support projection direction.

9. The flag assembly of claim 8 wherein the first and second portions of the hinge assembly comprise plates defining planes parallel to the first support projection direction and the second support projection direction.

10. The flag assembly of claim 8 wherein the angle is less than 90 degrees.

11. The flag assembly of claim 8 wherein the flag element comprises one of (a) through openings having a pattern resembling a flag and (b) an applique on a rigid panel resembling a flag.

12. The flag assembly of claim 8 further comprising:
a third support projecting from the mast at a third support location, the third support location being intermediate of the proximal end of the mast and the second support location, the third support projects away from the mast in a third support projection direction, the third support projection direction being parallel to the first support projection direction and the second support projection direction; and
a further panel disposed between the second and third supports.

13. The flag assembly of claim 12 wherein the further panel comprises a flag.

14. The flag assembly of claim 8 wherein the distal end of the mast comprises a light.

15. The flag assembly of claim 8 wherein the flag element has a conventional top and a conventional bottom, the conventional top of the flag element is adjacent the first support.

16. The flag assembly of claim 8 further comprising a light array adapted and configured to illuminate the flag element.
